(19) United States
(12) Patent Application Publication
(10) Pub. No.: US 2014/0313161 A1
(43) Pub. Date: Oct. 23, 2014

(54) ELECTRONIC WRITING BOARD

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/134,035

(22) Filed: Dec. 19, 2013

(30) Foreign Application Priority Data
Apr. 19, 2013 (TW) 102113883

(51) Int. Cl. G06F 3/041; G06F 3/045; G06F 3/043; G06F 3/044; G06F 3/042

(52) U.S. Cl. CPC G06F 3/0416; G06F 3/044; G06F 3/042; G06F 3/043; G06F 3/045
USPC 345/174; 345/173; 345/175; 345/177

(57) ABSTRACT

An electronic writing board includes a frame including inner sides, an electronic paper, a touch panel, and a driver. The electronic paper is stretched and connected to the inner sides of the frame. The touch panel is stretched and connected to the inner sides of the frame and covers the electronic paper. The driver is in communication with the touch panel and the electronic paper. The touch panel detects positions of an object when the object touches the touch panel and thus obtaining a trajectory of the object on the touch panel, and the driver drives the electronic paper to display a writing corresponding to the trajectory in shape and position.

### BACKGROUND

1. Technical Field

The present disclosure relates to writing boards, and particularly to an electronic writing board.

2. Description of Related Art

At present, writing boards are typically written on using ink pens. As such, the ink pen needs to be prepared in advance, which is inconvenient. In addition, the ink pen consumes ink, which increases cost.

Therefore, it is desirable to provide an electronic writing board that can overcome the above-mentioned problems.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

FIG. 1 is an isometric, schematic view of an electronic writing board in accordance with an embodiment.

FIG. 2 is a sectional view taken alone II-II line of the electronic writing board of FIG. 1.

### DETAILED DESCRIPTION

Embodiments of the present disclosure will be described with reference to the drawing.

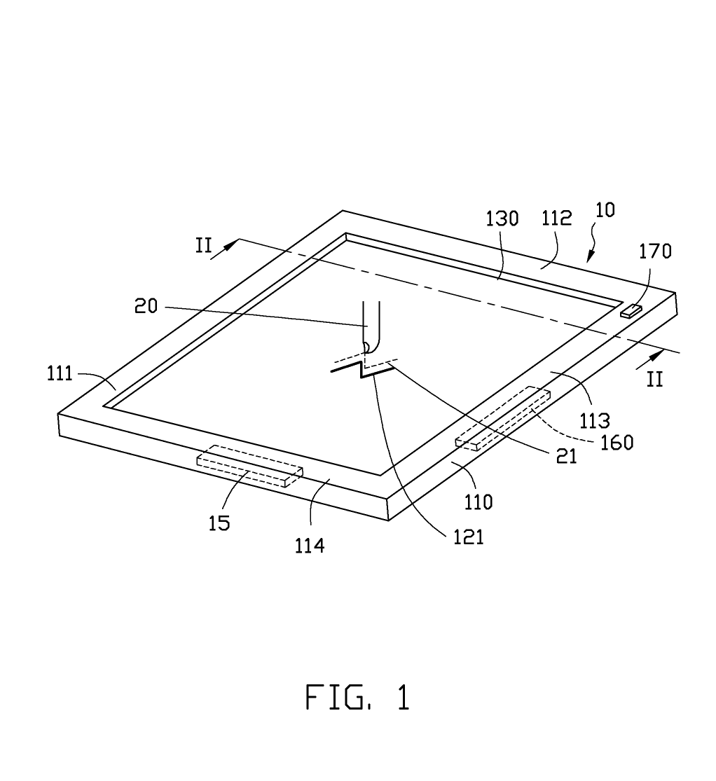

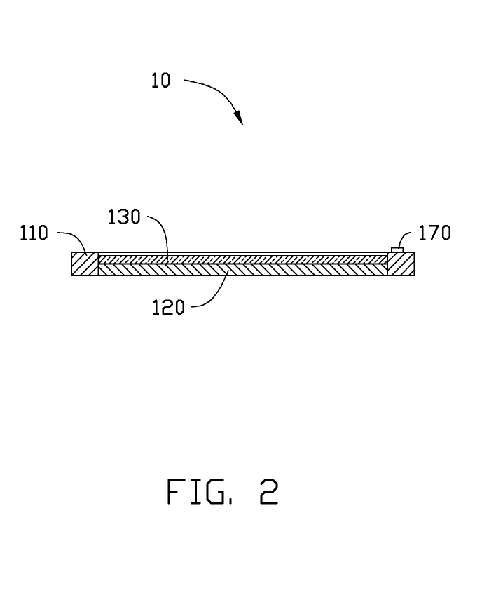

FIGS. 1 and 2 show an embodiment of an electronic writing board 10. The writing board 10 includes a frame 110, an electronic paper 120 stretched and connected to inner sides of the frame 110, a touch panel 130 stretched and connected to inner sides of the frame 110 and fully covering the electronic paper 120, and a driver 15 in communication with the touch panel 130 and the electronic paper 120. The touch panel 130 detects positions of an object 20 on the touch panel 130 when the object 20 touches the touch panel 130 to obtain a trajectory 21 of the object 20. The driver 15 is configured for driving the electronic paper 120 to display a writing 121 corresponding to the trajectory 21 in shape and position.

As such, the electronic writing board 10 can be written on by the object 20 which can be anything convenient for users, such as fingers. In addition, writing on the electronic writing board 10 does not consume ink or cause any contamination.

The frame 110 is substantially rectangular in this embodiment but can take other suitable forms in other embodiments. The frame 110 includes a first side 111, a second side 112, a third side 113, and a fourth side 114. The first side 111 is substantially parallel with the third side 113 and connected between one end of the second side 112 and one end of the fourth side 114. The third side 113 is connected between another end of the second side 112 and another end of the fourth side 114. The second side 112 is substantially parallel with the fourth side 114.

The electronic paper 120 is also substantially rectangular and can employ a cholesteric liquid crystal display, an electrophoretic display, or an electrowetting display. The electronic paper 120 can be a monochromatic display (white-black) or a color display, depending on need.

The electronic writing board 10 includes a power source 160. The electronic paper 120 is powered by the power source 160. The electronic paper 120 is a bistable display, that is, the electronic paper 120 can maintain an originally displayed image after the power source 160 is cut off. Therefore, the driver 15 cuts off the power source 160 from the electronic paper 120 when nothing is detected by the touch panel 130 and connects the power source 160 to the electronic paper 120 when the object 20 is detected by the touch panel 130. As such, a power consumption of the electronic writing board 10 can be reduced to further reduce cost.

The touch panel 130 can employ a capacitive touch panel, a resistive touch panel, an infrared touch panel, or a surface acoustic wave touch panel.

The driver 15 is received in the frame 110.

The electronic writing board 10 includes an eraser button 170 which is in communication with the driver 15. The driver 15 drives the electronic paper 120 to display a blank screen when the eraser button 170 is depressed to simulate an erasing action of conventional writing board.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electronic writing board, comprising:
a frame comprising inner sides;
an electronic paper stretched and connected to the inner sides of the frame;
a touch panel stretched and connected to the inner sides of the frame and covering the electronic paper; and
a driver in communication with the touch panel and the electronic paper;
wherein the touch panel detects positions of an object when the object touches the touch panel and thus to obtain a trajectory of the object on the touch panel, and the driver drives the electronic paper to display a writing corresponding to the trajectory in shape and position.

2. The electronic writing board of claim 1, wherein the frame is substantially rectangular and comprises a first side, a second side, a third side, and a fourth side, the first side is substantially parallel with the third side and connected between one end of the second side and one end of the fourth side, which are also substantially parallel with each other, the third side is connected between another end of the second side and another end of the fourth side.

3. The electronic writing board of claim 1, wherein the electronic paper is selected from the group consisting of a cholesteric liquid crystal display, an electrophoretic display, and an electrowetting display.

4. The electronic writing board of claim 1, wherein the electronic paper is selected from the group consisting of a monochromatic display and a color display.

5. The electronic writing board of claim 1, further comprising a power source, the electronic paper is powered by the power source, the electronic paper is a bistable display, and the driver cuts off the power source from the electronic paper when nothing is detected by the touch panel and connects the power source to the electronic paper when the object is detected by the touch panel.

6. The electronic writing board of claim 1, wherein the touch panel is selected from the group consisting of a capacitive touch panel, a resistive touch panel, an infrared touch panel, and a surface acoustic wave touch panel.

7. The electronic writing board of claim 1, further comprising an eraser button which is in communication with the driver, the driver being configured for driving the electronic paper to display a blank screen when the eraser button is depressed.
